(19) United States
(12) Patent Application Publication
(10) Pub. No.: US 2023/0268085 A1
(43) Pub. Date: Aug. 24, 2023

(54) NEUTRON MODERATORS COMPRISING A POROUS METAL HYDRIDE ARTICLE, NUCLEAR REACTORS INCLUDING THE SAME, AND RELATED METHODS

(71) Applicant: Battelle Energy Alliance, LLC, Idaho Falls, ID (US)

(72) Inventor: Chase N. Taylor, Idaho Falls, ID (US)

(21) Appl. No.: 18/171,923

(22) Filed: Feb. 21, 2023

Related U.S. Application Data
(60) Provisional application No. 63/268,298, filed on Feb. 21, 2022.

(51) Int. Cl. G21C 7/24; G21C 7/10; G21C 19/00

(52) U.S. Cl. CPC G21C 7/24; G21C 7/10; G21C 19/00

(57) ABSTRACT

A neutron moderator includes a porous metal hydride with channels within the porous metal hydride. Further, a method of regenerating a neutron moderator includes providing an at least partially depleted metal hydride article and introducing a hydrogen-containing gas into the at least partially depleted metal hydride article. The at least partially depleted metal hydride article includes channels. A nuclear reactor includes one or more neutron moderator regions in a core of a reactor, one or more fuel regions adjacent to the one or more neutron moderator regions, one or more heat transfer regions adjacent to the one or more fuel regions, control drums adjacent to the core, and a control rod adjacent to the core. One or more of the neutron moderator regions include a neutron moderator comprising a porous metal hydride article that has channels.

### CROSS-REFERENCE TO RELATED APPLICATION

This application claims the benefit under 35 U.S.C. § 119(e) of U.S. Provisional Patent Application Ser. No. 63/268,298, filed Feb. 21, 2022, the disclosure of which is hereby incorporated herein in its entirety by this reference.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

This disclosure relates generally to metal hydride structures and to methods of forming the metal hydride structures. More specifically, this disclosure relates to neutron moderators including the metal hydride structures, to methods of forming the metal hydride structures, and to methods of regenerating the metal hydride structures.

### BACKGROUND

Neutron moderators are a class of compounds that scatter neutrons, thus slowing their velocity (e.g., for neutrons emitted from a fissile compound within a nuclear reactor). Neutron moderators may optimize fission chain reactions because slower neutrons can increase nuclear reaction efficiency and output. Metal hydrides, which may be used as neutron moderators, are important for accessing high temperature nuclear reactor implementation, owing to their high thermal stability and high hydrogen density when compared to lower temperature nuclear reactor moderators such as water. However, conventional high temperature nuclear reactors that use metal hydrides as moderators may be lifetime limited by both fuel source and moderator efficacy since the effectiveness of the moderator may degrade over time due to hydrogen loss at higher temperatures. The potential for irreversible hydrogen depletion may occur over time under normal operating conditions, and/or if the heat transfer properties of the metal hydride moderator are altered because of swelling, blister formation, delamination, or in the case of an off-normal temperature excursion.

Nuclear reaction moderators that have conventionally been used include metal hydrides, water, heavy water, beryllium oxide, and graphite. A common quality of some effective neutron moderators is the presence of hydrogen atoms in the moderator. One consequence of collisions between neutrons and the neutron moderator containing hydrogen atoms may be that the hydrogen atoms are expelled from the neutron moderator, leading to eventual hydrogen depletion and loss of effectiveness of the substance as a neutron moderator, especially at higher temperatures.

### BRIEF SUMMARY

In accordance with embodiments of the disclosure, a neutron moderator includes a porous metal hydride comprising channels within the porous metal hydride.

Further, in accordance with embodiments of the disclosure, a nuclear reactor includes one or more neutron moderator regions in a core of a reactor, one or more fuel regions, one or more heat transfer regions, control drums adjacent to the core, and a control rod adjacent to the core. The one or more of the one or more neutron moderator regions include a neutron moderator. The neutron moderator has a porous metal hydride article with channels. The one or more fuel regions are adjacent to the one or more neutron moderator regions. The one or more heat transfer regions are adjacent to the one or more fuel regions.

Further, in accordance with other embodiments of the disclosure, a method of forming a metal hydride includes forming a porous network scaffold, infiltrating a metal hydride material into the porous network scaffold, and removing the porous network scaffold to form a porous metal hydride article.

Additionally, in accordance with other embodiments of the disclosure, a method of regenerating a neutron moderator includes providing an at least partially depleted metal hydride article, and introducing a hydrogen-containing gas into the at least partially depleted metal hydride article. The at least partially depleted metal hydride article has channels.

### BRIEF DESCRIPTION OF THE DRAWINGS

FIGS. 1A through 1C are a simplified, conceptual depiction of a process of forming a porous metal hydride article in accordance with embodiments of the disclosure.

FIGS. 2A through 2D are conceptual SEM micrographs of a metal hydride (MHₓ) article in accordance with embodiments of the disclosure.

FIG. 3 is a simplified, perspective view of a porous metal hydride moderator encased within a metal cladding in accordance with embodiments of the disclosure.

FIG. 4 is a simplified, section view of a core in accordance with embodiments of the disclosure.

FIG. 5 is a simplified, section view of a nuclear reactor core in accordance with embodiments of the disclosure.

### DETAILED DESCRIPTION

The following description provides specific details, such as material compositions, shapes, and sizes, in order to provide a thorough description of embodiments of the disclosure. However, a person of ordinary skill in the art would understand that the embodiments of the disclosure may be practiced without employing these specific details. Indeed, the embodiments of the disclosure may be practiced in conjunction with conventional techniques employed in the industry.

Drawings presented herein are for illustrative purposes only, and are not meant to be actual views of any particular material, component, structure, or system. Variations from the shapes depicted in the drawings as a result, for example, of manufacturing techniques and/or tolerances, are to be expected. Thus, embodiments described herein are not to be construed as being limited to the particular shapes. The drawings are not necessarily to scale.

As used herein, the singular forms “a,” “an,” and “the” are intended to include the plural forms as well, unless the context clearly indicates otherwise. As used herein, “and/or” includes any and all combinations of one or more of the associated listed items.

As used herein, the term “substantially” in reference to a given parameter, property, or condition means and includes to a degree that one of ordinary skill in the art would understand that the given parameter, property, or condition is met with a degree of variance, such as within acceptable tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, “about” or “approximately” in reference to a numerical value for a particular parameter is inclusive of the numerical value and a degree of variance from the numerical value that one of ordinary skill in the art would understand is within acceptable tolerances for the particular parameter. For example, “about” or “approximately” in reference to a numerical value may include additional numerical values within a range of from 80.0 percent to 120.0 percent of the numerical value, such as within a range of from 90.0 percent to 110.0 percent of the numerical value, within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, porosity of a given material or article is described as a percentage of a volume of voids (e.g., empty pore space) in the material or article divided by a total volume of the material or article (e.g., the combined volume of both the material or article and the voids). As such, porosity may be described as a volumetric percentage (“vol. %”).

As used herein, the term “moderator” (e.g., “neutron moderator”) means a material that is configured to be placed within a nuclear reactor core and formulated to decrease the velocity of high-energy neutrons within the nuclear reactor.

As used herein, the term “MHₓ” refers to a metal hydride, where “x” may refer to the number of hydrogen atoms per unit lattice. The MHₓ may be a stoichiometric compound of the metal atoms and hydrogen atoms, or a non-stoichiometric compound of the metal atoms and hydrogen atoms. The metal hydride may be configured as an MHₓ material, an MHₓ intermediate structure, and/or an MHₓ article.

Conventionally, MHₓ neutron moderators may be formed by exposing a metal (e.g., yttrium) to a gas (e.g., hydrogen) at high temperature. Over time (e.g., several days), the metal may uniformly hydride by reaching a hydrogen concentration sufficient to be utilized for a neutron moderator. However, hydriding the metal at too fast of a rate may result in cracking and mechanical failure of the metal hydride. Use of the neutron moderator at a high temperature may be limited in effectiveness by the eventual loss of hydrogen from the MHₓ neutron moderator, which may be exacerbated by the high operating temperatures of a nuclear microreactor in which the MHₓ neutron moderator is used.

Attempts to re-hydride conventional MHₓ neutron moderators by introducing hydrogen into the MHₓ neutron moderator in situ (e.g., within the nuclear reactor) may be ineffective, as hydride processes typically cause expansion of the MHₓ neutron moderator, which can cause cracking and eventual disintegration of the MHₓ neutron moderator.

Disclosed is a method of regenerating a depleted MHₓ article that enables control over hydride concentration in the MHₓ article. The MHₓ article may, for example, be configured as a MHₓ moderator (e.g., a MHₓ neutron moderator) in a nuclear reactor, such as in a microreactor. Microreactors are compact nuclear reactors that are capable of generating a power output from approximately 1 megawatt (“MW”) to approximately 20 MW and operate at a temperature from about 400° C. to about 1,000° C. Using the MHₓ article according to embodiments of the disclosure may increase the effective lifetime over which reliable operation of the nuclear reactor may occur. More specifically, the MHₓ article may be used as a neutron moderator that is formulated and configured to regenerate its hydrogen density. The MHₓ article may be porous such that a flow of gas therethrough regenerates the MHₓ article following hydrogen depletion.

The operating temperatures of nuclear reactors above certain temperatures (e.g., greater than or equal to about 400° C., such as greater than or equal to about 600° C. or greater than or equal to about 800° C.) may be limited by neutron moderator selection and long-term efficacy. Metal hydrides may provide efficient neutron moderation in nuclear reactors, but may be limited in long-term efficacy by hydride loss, which decreases a moderating ratio of the MHₓ article. Neutron moderator performance is quantified by a moderating ratio, defined as the macroscopic slowing-down power (the product of the average logarithmic energy loss per collision and the macroscopic neutron scattering cross section) to the macroscopic cross section for neutron absorption.

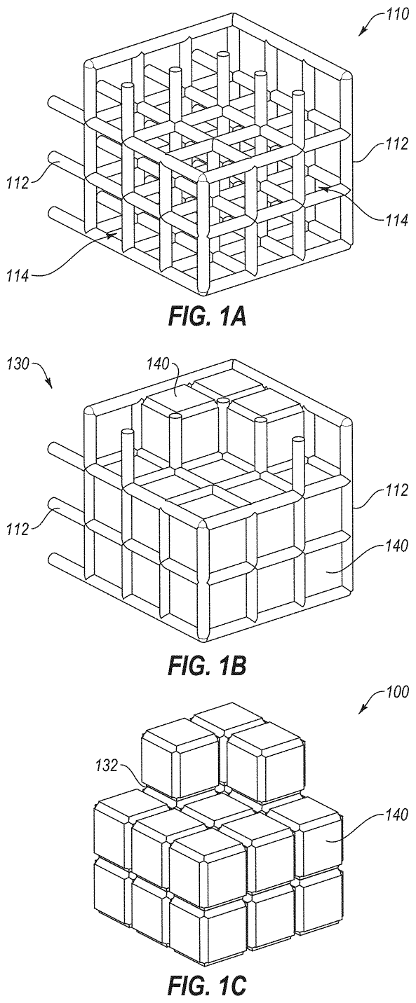

An MHₓ neutron moderator (e.g., the MHₓ article) may be porous (e.g., may exhibit pores), such as including channels (e.g., internal channels) throughout the bulk of the MHₓ article. Porous regions of the MHₓ article may enable a gas to flow through the MHₓ article, which enables regeneration of the MHₓ article (e.g., an increase of hydrogen content in the MHₓ article). The channels extend through the MHₓ article and may be substantially uniformly distributed through the MHₓ material, providing porosity to the MHₓ article. The channels may be substantially linear, as shown in FIG. 1C, or may be interconnected with one another (not shown). Tailoring the porosity of the MHₓ article may be achieved by adjusting the volume percent density of the interconnected and open internal channels, such as achieving from about 0.01% by volume to about 20% by volume porosity. The MHₓ article may exhibit a porosity of from about 0.01 vol. % to about 2.0 vol. %, from about 2.0 vol. % to about 5.0 vol. %, from about 5.0 vol. % to about 10 vol. %, or from about 10 vol. % to about 20 vol. %. The interconnected and open internal channels of the MHₓ article may be sized, shaped, and otherwise configured to tailor (e.g., control) hydrogen density and/or gas flow through the MHₓ article. The MHₓ article may comprise a so-called “reverse foam” article, formed from melt infiltration of MHₓ material into cells of a foam and subsequent removal of the foam, as will be described in further detail below.

Referring to FIGS. 1A-1C, forming a porous MHₓ article 100 (FIG. 1C) may include forming a porous network scaffold 110 (e.g., a porous foam structure), from which the MHₓ article 100 may later be prepared. The porous network scaffold 110 depicted in FIG. 1A is a conceptual representation of a precursor material that may be utilized to form the MHₓ article 100. The porous network scaffold 110 includes scaffold members 112 that define openings 114. The porous network scaffold 110 may be formed of a material that is formulated and configured to withstand process conditions (e.g., temperatures and pressures) utilized to prepare the MHₓ article 100. The porous network scaffold 110 may comprise an open-cell foam, such as a carbon foam. In some embodiments, the carbon foam is a polyurethane foam.

The porous network scaffold 110 may be formed by impregnating a precursor foam (e.g., a polyurethane open-cell foam) with resin (e.g., a thermal setting resin, such as a carbonaceous resin or a carbonaceous thermal setting resin). The resin-impregnated precursor foam may be heated to cure (e.g., thermally set) the resin, while maintaining the precursor foam at temperatures below the decomposition temperature of the precursor foam. The resin-impregnated precursor foam may be subjected to one or more temperature gradients to cure the resin. By way of non-limiting example, the resin-impregnated precursor foam may be subjected to a first temperature gradient comprising heating the resin-impregnated precursor foam at rates from approximately 0.05° C. per minute to approximately 0.7° C. per minute until reaching approximately 50° C. to approximately 90° C. In one embodiment, the resin-impregnated precursor foam is subjected to heating at a rate of approximately 0.16° C. per minute until reaching approximately 70° C.

Following the first temperature gradient, the resin-impregnated precursor foam may be maintained at holding temperatures at or below an exothermic temperature of the resin in order to control (e.g., limit) the amount of heat released into the precursor foam. As a non-limiting example, holding temperatures may range from approximately 50° C. to approximately 120° C. for a duration of from approximately 1 hour to approximately 15 hours. In one embodiment, the resin-impregnated precursor foam is held at a temperature of approximately 70° C. for approximately 3 hours.

Following subjecting the resin-impregnated precursor foam to a prolonged holding temperature, the resin-impregnated precursor foam may be subjected to a second or other subsequent temperature gradient.

By way of non-limiting example, the resin-impregnated precursor foam may be subjected to a second temperature gradient comprising heating the resin-impregnated precursor foam at rates from approximately 0.03° C. per minute to approximately 0.13° C. per minute until reaching approximately 150° C. to approximately 190° C. In one embodiment, the resin-impregnated precursor foam is subjected to heating at a rate of approximately 0.09° C. per minute until reaching approximately 170° C. The second temperature gradient may enable a substantially complete thermal setting of the resin, while allowing exothermic heat of the thermal setting of the resin to dissipate without substantially affecting the cell shape of the resin-impregnated precursor foam. Following the second temperature gradient ramp, the resin-impregnated precursor foam may be allowed to cool to room temperature (e.g., approximately 20° C. to approximately 22° C.).

Curing the resin within the resin-impregnated precursor foam may comprise forming crosslinks in the resin impregnated within the precursor foam. Curing the resin impregnated within the precursor foam article may be performed in an inert atmosphere (e.g., nitrogen or argon), in a non-oxidizing atmosphere (e.g., hydrogen), or in a vacuum.

Following curing the resin in the precursor foam, the precursor foam may be heated to pyrolyzing temperatures of the precursor foam for a sufficient duration of time to convert the carbonaceous resin impregnated within the precursor foam to, for example, vitreous carbon (e.g., by vitrifying the resin), resulting in the porous network scaffold 110. As a non-limiting example, pyrolyzing temperatures may range from approximately 400° C. to approximately 2200° C. As a further non-limiting example, the pyrolyzing duration may range from approximately 1 hour to approximately 60 hours. Pyrolyzing the precursor foam may be performed in an inert atmosphere (e.g., nitrogen or argon), in a non-oxidizing atmosphere (e.g., hydrogen), or in a vacuum.

The porosity of the later-formed porous MHₓ article 100 (FIG. 1C) may be controlled through selective formation of the scaffold members 112 of the porous network scaffold 110. For example, tailoring a thickness of the scaffold members 112 of the porous network scaffold 110 may affect the porosity of the later-formed MHₓ article 100. By way of example only, forming a thicker porous network scaffold 110 (e.g., by forming thicker scaffold members 112) may result in an increased porosity of the MHₓ article 100 relative to forming a thinner porous network scaffold 110 (e.g., by forming thinner scaffold members 112). By way of example, the porous network scaffold 110 may comprise a reticulated vitreous carbon (“RVC”) foam. The RVC foam may form a network of interconnected structures, also referred to as foam ligaments, analogous to the scaffold members 112. Although the scaffold members 112 are conceptually depicted in FIGS. 1A and 1B as linear, uniform, and parallel or orthogonal elements relative to each other, the scaffold members 112 (e.g., foam ligaments) may comprise nonuniform, non-linear (e.g., irregularly-shaped), twisted, uneven, and/or oblique elements relative to each other. In some embodiments, an RVC foam is initially formed to exhibit a pore size of from about 3 pores per linear inch (“ppi”) to about 130 ppi, and then the thicknesses of the individual foam ligaments are increased by infiltrating the RVC foam using chemical vapor infiltration (“CVI”) until the porous network reaches a desired density (e.g., 10 vol. % dense). As further examples, the scaffold members 112 of the porous network scaffold 110 may be enlarged (e.g., increased in diameter) by conducting deposition or epitaxy on the porous network scaffold 110 including, but are limited to atomic layer deposition, electro deposition, electro-less deposition, chemical vapor deposition, or physical vapor deposition.

Following formation of the porous network scaffold 110, a protective interlayer (not depicted) may optionally be applied to the scaffold members 112 of the porous network scaffold 110 (e.g., foam ligaments of an RVC foam structure) to protect the scaffold members 112 from subsequent acts carried out in forming an MHₓ intermediate structure 130 (e.g., melt infiltration of MHₓ material 140 into the porous network scaffold 110 as depicted in FIG. 1B). By way of example, tungsten may be used as the protective interlayer. The protective interlayer may be applied to the scaffold members 112 of the porous network scaffold 110 using conventional techniques. By way of example, a thin layer of tungsten may be applied to the scaffold members 112 of the porous network scaffold 110 using chemical vapor deposition. The material of the protective interlayer may be selected such that any remaining protective interlayer material (e.g., tungsten), following the removal of the porous network scaffold 110 from the MHₓ intermediate structure 130, does not substantially prevent permeation of hydrogen gas through the MHₓ article 100 nor formation of bonds between hydrogen and MHₓ material 140 in the MHₓ article 100. Alternatively, the protective interlayer may be partially or substantially removed following removal of the of the porous network scaffold 110 from the MHₓ intermediate structure 130, which may permit sufficient permeation of hydrogen through the MHₓ article 100.

Referring to FIG. 1B, following formation of the porous network scaffold 110, the MHₓ intermediate structure 130 may be formed by infiltrating an MHₓ material 140 into and around the porous network scaffold 110 (e.g., into openings 114). By way of non-limiting example, the MHₓ material 140 may be infiltrated into the porous network scaffold 110, followed by heating the MHₓ material 140 to a temperature above its melting point to melt the MHₓ material 140 into the porous network scaffold 110. The MHₓ material 140 may be used in a powder form, which is commercially available from numerous sources. Afterward, the MHₓ material 140 may be allowed to cool to solidify into the MHₓ intermediate structure 130. The MHₓ intermediate structure 130 may be formed such that when the porous network scaffold 110 is removed, the resulting MHₓ article 100 comprises numerous pores 132 (e.g., interconnected channels). Although the MHₓ intermediate structure 130 and MHₓ article 100 are respectively conceptually depicted in FIGS. 1B and 1C as having regular, uniform, and cubic elements arranged in a repeating three-dimensional tessellated pattern relative to each other, the MHₓ material 140 of the MHₓ intermediate structure 130 and of the MHₓ article 100 may be configured as nonuniform, irregularly-shaped elements arranged in nonrepeating three-dimensional patterns relative to each other.

The metal of the MHₓ material 140 of the MHₓ intermediate structure 130 and of the MHₓ article 100 may be an alkali metal, a transition metal, an actinide, or an alloy (including, as examples, a conventional alloy or a high-entropy alloy) thereof. The metal may include, but is not limited to, one or more of yttrium, cerium, zirconium, chromium, titanium, lithium, thorium, or uranium. By way of example, the MHₓ material 140 may comprise one or more of yttrium hydride, cerium hydride, yttrium zirconium hydride, yttrium chromium hydride, titanium hydride, zirconium hydride, lithium hydride, thorium hydride, uranium hydride, thorium zirconium hydride, or thorium titanium hydride. In some embodiments, the MHₓ material 140 is yttrium hydride.

Following formation of the MHₓ intermediate structure 130, the porous network scaffold 110 may be removed. Referring to FIG. 1C, removal of the porous network scaffold 110 may result in the MHₓ article 100 having an interconnected porous network throughout the MHₓ material 140. By way of non-limiting example, the porosity of the MHₓ article 100 may be from about 0.01 vol. % to about 20 vol. % porosity, such as about 3 vol. % porosity. The pores 132 are configured and formulated to be able to flow a gas therethrough. The porous network scaffold 110 may be removed by oxidation (e.g., burning), electroetching, or chemically dissolution. In some embodiments, the porous network scaffold 110 is removed by oxidation. In other embodiments, the porous network scaffold 110 is removed by using a conventional electroetching process. In yet other embodiments, the porous network scaffold 110 (e.g., formed from a precursor polyurethane open-cell foam) is removed by chemically dissolving the porous network scaffold 110. The MHₓ article 100 may be stable at high temperatures, such as at temperatures from about 400° C. to above 1,000° C. In particular, the MHₓ article 100 may be stable at temperatures greater than or equal to about 400° C., greater than or equal to about 500° C., greater than or equal to about 600° C., greater than or equal to about 700° C., greater than or equal to about 800° C., or greater than or equal to about 1,000° C.

The formation of the MHₓ article 100 may, for example, be performed under vacuum conditions, such as under ultrahigh vacuum conditions. By way of example only, the MHₓ intermediate structure 130 may be formed (e.g., by melt infiltration of the MHₓ material into the porous network scaffold 110) at a pressure from approximately 1×10⁻⁸ mbar to approximately atmospheric pressure (e.g., in an inert gas such as argon). If the MHₓ intermediate structure 130 is subjected to deposition (e.g., chemical vapor deposition), such processing acts may be carried out at a pressure from approximately 0.1 mbar to approximately 100 mbar. Removal (e.g., oxidation) of the porous network scaffold 110 may be carried out at atmospheric pressure followed by substantially outgassing residual matter of the porous network scaffold 110 at ultrahigh vacuum conditions (e.g., at or below approximately 1×10⁻⁸ mbar). The formation of the MHₓ article 100 may alternatively be formed under atmospheric conditions. The formation of the MHₓ article 100 may be performed under high pressure conditions. By way of further example, the formation of the MHₓ article 100 may be performed at a pressure from about 1×10³ mbar to about 1×10⁹ mbar. The formation of the MHₓ article 100 may also be performed under a gas atmosphere (e.g., hydrogen).

Alternatively, the MHₓ article 100 may be formed from an MHₓ precursor material that is infiltrated around the porous network scaffold 110 to form a porous MHₓ precursor (not shown). The MHₓ article 100 may be formed following the formation of such a porous MHₓ precursor. More specifically, the porous network scaffold 110 may be infiltrated with a non-hydride precursor material of the MHₓ, to form a porous non-hydride metal (e.g., the porous MHₓ precursor), which may subsequently be converted to the MHₓ article 100. For instance, the MHₓ article 100 may be formed by hydriding the porous MHₓ precursor (e.g., by exposing the porous MHₓ precursor to hydrogen over time at high temperature). Hydriding the porous MHₓ precursor may be carried out by introducing hydrogen gas into the porous MHₓ precursor at a pressure from approximately 1×10⁻¹⁰ mbar to approximately 1000 mbar. The hydrogen gas pressure may be provided at a substantially constant pressure, or may be gradually increased (e.g., from approximately 1×10⁻¹⁰ mbar to approximately 1000 mbar).

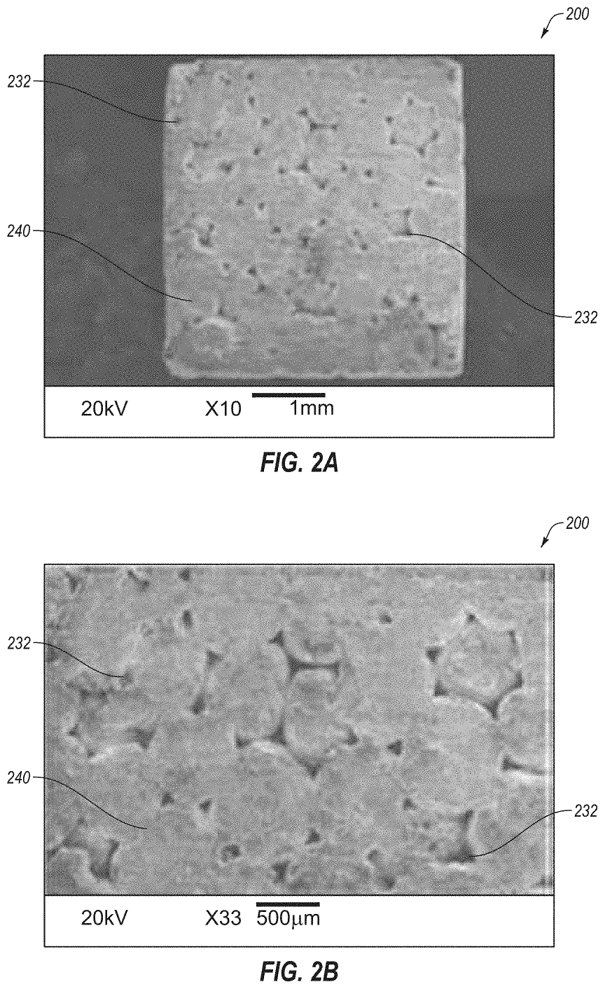

Referring to FIGS. 2A through 2D, an example embodiment of an MHₓ article 200, formed as described above with respect to the MHₓ article 100, is conceptually depicted. The MHₓ article 200 comprises an interconnected porous network throughout an MHₓ material 240, the pores 232 of which are configured and formulated to be able to flow a gas therethrough. FIG. 2A illustrates the MHₓ article 200 at a 10× magnification, FIG. 2B illustrates the MHₓ article 200 at a 33× magnification, FIG. 2C illustrates the MHₓ article 200 at a 23× magnification, and FIG. 2D illustrates the MHₓ article 200 at a 40× magnification.

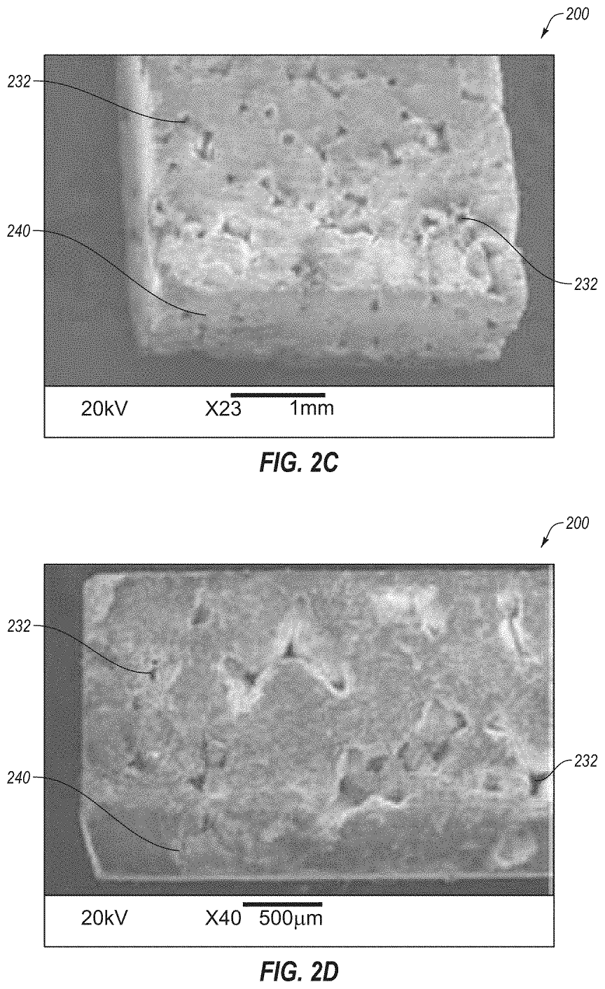

Methods for forming an MHₓ article 100, 200, as disclosed herein, may enable formation of the pores 132, 232 of the MHₓ article 100, 200 to have sizes and shapes that may be configured for use in an MHₓ moderator 300 (e.g., an MHₓ neutron moderator) of a nuclear reactor. FIG. 3 illustrates a schematic perspective view of an MHₓ moderator 300 comprising an MHₓ article 310, formed as described above with respect to the MHₓ article 100, encased within a cladding 302. The cladding 302 may substantially surround the MHₓ article 310. If the MHₓ article 310 becomes partially or substantially depleted of hydrogen during use and operation, gas 304 (e.g., hydrogen) may be flowed through the MHₓ article 310, which is porous, hydriding the depleted MHₓ article 310 (e.g., increasing the hydrogen content of the depleted MHₓ article 310) to replace the hydrogen depleted during operation of the MHₓ moderator 300 within the nuclear reactor.

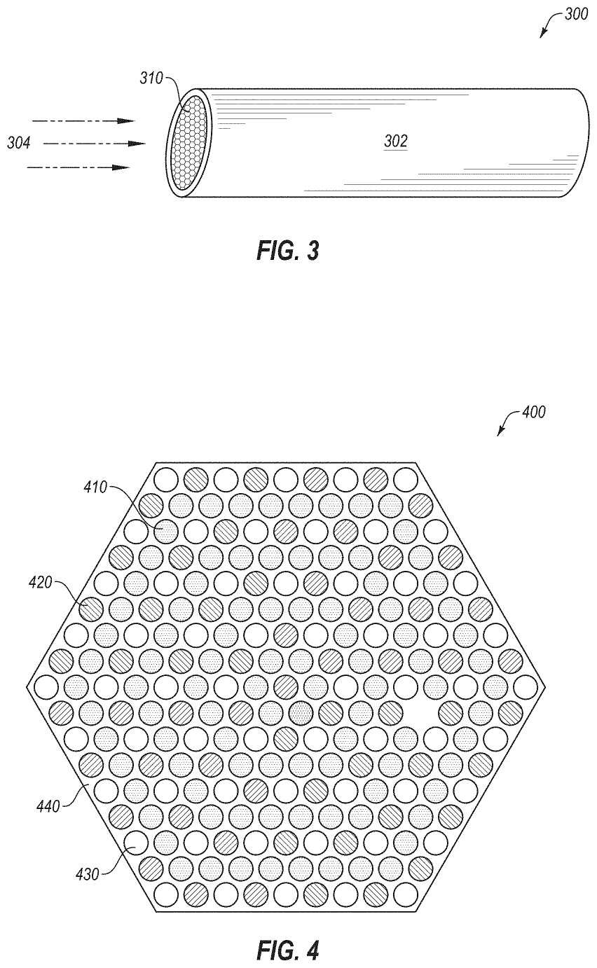

Referring to FIG. 4, a core 400 of a nuclear reactor is depicted as having one or more moderator regions 410, one or more fuel regions 420, one or more heat pipe regions 430, and a monolith structure 440. The moderator regions 410 may comprise MHₓ moderators (e.g., MHₓ moderator 300) individually comprising an MHₓ article (e.g., MHₓ article 100, MHₓ article 200) with an interconnected porous network throughout the MHₓ article 100. The MHₓ moderators (e.g., MHₓ moderator 300) in the moderator regions 410 may exhibit a moderating ratio greater than about two. The moderator regions 410 may include the network of internal channels through which the gas (e.g., hydrogen) may be flowed to regenerate the hydrogen of the MHₓ moderators (e.g., MHₓ moderator 300). Heat pipes of the heat pipe regions 430 may be configured to transfer heat produced by the fuel regions 420 out of the core 400. While FIG. 4 depicts a specific configuration of components, the core 400 may include different configurations of the moderator regions 410, fuel regions 420, heat pipe regions 430, and monolith structure 440.

Although the foregoing descriptions are provided with reference to formation of an MHₓ article (e.g., MHₓ articles 100, 200, 310) by melt infiltration of the MHₓ material (e.g., MHₓ material 140) into a porous network scaffold (e.g., porous network scaffold 110), other embodiments of the disclosure include MHₓ articles that are formed using a variety of techniques and processes to result in porous MHₓ articles comprising a porosity of between about 0.01 vol. % and about 20 vol. %. As non-limiting examples, the MHₓ article (e.g., MHₓ articles 100, 200, 310) may be formed by additive manufacturing techniques. For example, partial sintering may be carried out to form a porous MHₓ article having a desired porosity and other physical characteristics appropriate for use as an MHₓ moderator. Other techniques of forming an MHₓ article configured to allow a gas (e.g., hydrogen) to flow therethrough are within the scope of the disclosure.

Processes as described herein may enable selection and variation in the extent of porosity and flow characteristics of the MHₓ articles (e.g., MHₓ articles 100, 200, 310) in combination with the moderator neutron efficacy. The moderator regions 410 may be present in the core 400 and configured to allow the gas (e.g., hydrogen gas) to flow through the moderator regions 410. By adjusting the thickness and configuration of the porous network scaffold 110, dimensions (e.g., a width, a length) of the pores 132, 232 may be tailored. The porosity of the moderator regions 410 of the core 400 may allow for in situ regeneration of the MHₓ article 100, 200, 310, which may improve the effectiveness and lifetime of the MHₓ articles 100, 200, 310 of the reactor. By regenerating the MHₓ article 100, 200, 310 according to embodiments of the disclosure, lifetime limitations observed with conventional MHₓ moderators may be overcome. In contrast, conventional MHₓ moderators are not easily and reliably regenerated following hydride loss. Instead, core replacement is necessary when the conventional MHₓ moderators are depleted.

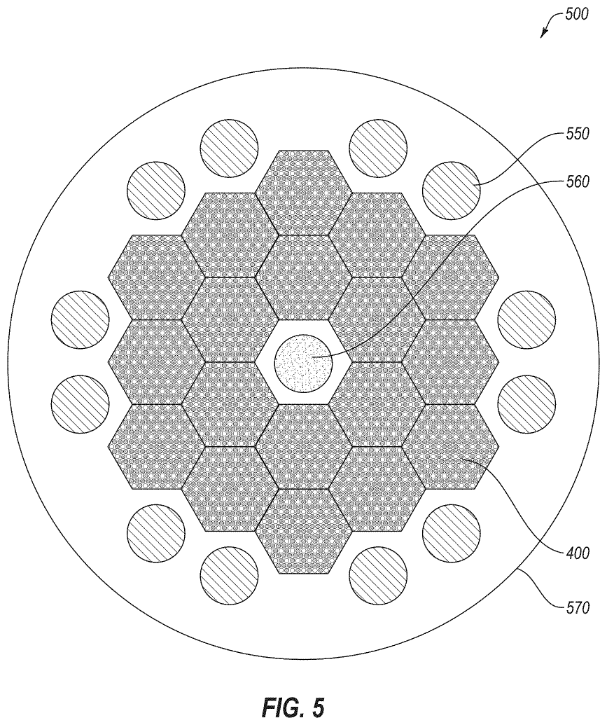

Referring to FIG. 5, a reactor core 500 may comprise multiple cores 400, control drums 550, and a control rod 560 (e.g., shutdown rod) within a core barrel 570. The heat pipe regions 430 may be used to transfer heat produced by the fuel regions 420 out of the reactor core 500 to a secondary side of the reactor, which may include heat exchangers (not shown) configured to extract heat from the heat pipe regions 430. The control drums 550 may comprise a neutron-reflecting material and a neutron absorbing material and may be configured to control the reflection of neutrons emitted from the cores 400. Thus, fission chain reactions within the reactor core 500 may be increased by directing the control drums 550 to reflect more neutrons back toward the center of the reactor core 500 (e.g., back into the cores 400). Conversely, the fission chain reactions may be decreased by directing the control drums 550 to absorb more neutrons. The control rod 560 may comprise an elongated rod of neutron-absorbing material, and may be configured to absorb a portion of neutrons passing between the fuel regions 420 when inserted into the core barrel 570, which neutrons may otherwise contribute to the fission chain reactions. Thus, the control rod 560 may function to slow or substantially stop the fission chain reactions within the reactor core 500 when inserted.

In operation, the moderator articles (e.g., MHₓ article 100, MHₓ article 200, MHₓ article 310) of the moderator regions 410 may be used at a high temperature (e.g., at or above about 400° C.) within the reactor core 500 or during an unplanned temperature excursion. During such use, the MHₓ material 140 may experience a loss of hydrogen over time, becoming depleted. Gas flow (e.g., hydrogen gas) through the MHₓ articles 100, 200, 310 may enable regeneration of the hydrogen within the MHₓ articles 100, 200, 310. By way of example, about 20% or more of the depleted hydrogen may be regenerated, such as about 40% or more of the depleted hydrogen, about 60% or more of the depleted hydrogen, about 80% or more of the depleted hydrogen, or about 100% of the depleted hydrogen may be regenerated. The regeneration of the hydrogen may be performed at a temperature at or above about 400° C. The gas (e.g., hydrogen) may be flowed through the MHₓ articles (e.g., MHₓ article 100, MHₓ article 200, MHₓ article 310) at a flow rate sufficient to regenerate the hydrogen, which depends on the extent of hydrogen depletion and the dimensions of the pores (e.g., pores 132, 232). The flow of gas through the moderator regions 410 may also function as a heat transfer medium. Conditions (e.g., temperature, pressure, hydrogen flow rate) for regenerating the MHₓ articles (e.g., MHₓ article 100, MHₓ article 200, MHₓ article 310) may be selected to minimize and/or stop cracking or mechanical failure in the MHₓ articles (e.g., MHₓ article 100, MHₓ article 200, MHₓ article 310). By way of non-limiting example, the MHₓ article (e.g., MHₓ article 100, MHₓ article 200, MHₓ article 310) may be regenerated (e.g., hydrided) by either static hydrogen gas or flowing hydrogen gas. For any given MHₓ article (e.g., MHₓ article 100, MHₓ article 200, MHₓ article 310), there may be a hydrogen gas equilibrium pressure for rejuvenation and/or maintenance of hydrogen content in the MHₓ article. Introducing hydrogen gas at least at the equilibrium pressure into the MHₓ article may result in hydridation of the MHₓ article, which may at least offset depletion of hydrogen from the MHₓ article that occurs during operation of the nuclear reactor. The equilibrium pressure of introduced hydrogen may be less than or equal to approximately 1000 torr. Alternatively, the MHₓ article may be regenerated by introducing hydrogen gas into the MHₓ article at a pressure from approximately 1×10⁻¹⁰ mbar to approximately 1000 mbar. The hydrogen gas pressure may be provided at a substantially constant pressure, or may be gradually increased (e.g., from approximately 1×10⁻¹⁰ mbar to approximately 1000 mbar). Additional equilibrium processing conditions (e.g., temperature, gas flow rate) may likewise contribute to rejuvenation of the MHₓ article.

Regenerating the hydrogen in the moderator regions 410 may be achieved by flowing the gas through the MHₓ material 140, MHₓ material 240 of the moderator regions 410. Regeneration of the MHₓ material may be limited by diffusion and thermodynamic (e.g., temperature, pressure) processes. The hydrogen may be regenerated in situ during use and operation of the nuclear reactor core 500. Alternatively, the moderator regions 410 may be regenerated when the nuclear reactor is offline (e.g., inactive). Interaction of the gas (e.g., hydrogen) with the hydrogen-depleted MHₓ material of the moderator regions 410 may regenerate the moderator efficacy since the MHₓ material of the moderator regions 410 is structurally porous. Therefore, the MHₓ article (e.g., MHₓ article 100, MHₓ article 200, MHₓ article 310) in the moderator region 410 may be formulated and configured to continuously replenish their hydrogen content. The reactor core 500, thus configured to operate at a high temperature (e.g., above about 400° C.), that includes the MHₓ article (e.g., MHₓ article 100, MHₓ article 200, MHₓ article 310) according to embodiments of the disclosure may enable the lifetime of the reactor core 500 to be fuel limited rather than moderator lifetime limited.

While certain illustrative embodiments have been described in connection with the figures, those of ordinary skill in the art will recognize and appreciate that embodiments encompassed by the disclosure are not limited to those embodiments explicitly shown and described herein. Rather, many additions, deletions, and modifications to the embodiments described herein may be made without departing from the scope of embodiments encompassed by the disclosure, such as those hereinafter claimed, including legal equivalents. In addition, features from one disclosed embodiment may be combined with features of another disclosed embodiment while still being encompassed within the scope of the disclosure.

What is claimed is:

1. A neutron moderator, comprising:
a porous metal hydride comprising channels within the porous metal hydride.

2. The neutron moderator of claim 1, wherein the porous metal hydride exhibits a porosity of from about 0.01% by volume to about 20% by volume.

3. The neutron moderator of claim 1, wherein the porous metal hydride comprises a metal hydride selected from the group consisting of yttrium hydride, cerium hydride, yttrium zirconium hydride, yttrium chromium hydride, titanium hydride, zirconium hydride, lithium hydride, thorium hydride, uranium hydride, thorium zirconium hydride, thorium titanium hydride, and a combination thereof.

4. The neutron moderator of claim 1, wherein the channels are uniformly distributed within the neutron moderator.

5. The neutron moderator of claim 1, wherein the channels are randomly distributed throughout the neutron moderator.

6. A nuclear reactor, comprising:
one or more neutron moderator regions in a core of a reactor, one or more of the one or more neutron moderator regions including a neutron moderator comprising a porous metal hydride article comprising channels;
one or more fuel regions adjacent to the one or more neutron moderator regions;
one or more heat transfer regions adjacent to the one or more fuel regions;
control drums adjacent to the core; and
a control rod adjacent to the core.

7. The nuclear reactor of claim 6, further comprising a cladding substantially surrounding the porous metal hydride article.

8. The nuclear reactor of claim 6, wherein the porous metal hydride article comprises yttrium hydride.

9. The nuclear reactor of claim 6, wherein the reactor is configured as a microreactor.

10. A method of forming a metal hydride article, comprising:
forming a porous network scaffold;
infiltrating a metal hydride material into the porous network scaffold; and
removing the porous network scaffold to form a porous metal hydride article.

11. The method of claim 10, wherein forming a porous network scaffold comprises forming a foam comprising interconnected foam ligaments.

12. The method of claim 10, wherein removing the porous network scaffold comprises oxidizing the porous network scaffold.

13. The method of claim 10, wherein infiltrating a metal hydride material into the porous network scaffold comprises infiltrating a metal hydride selected from the group consisting of yttrium hydride, cerium hydride, yttrium zirconium hydride, yttrium chromium hydride, titanium hydride, zirconium hydride, lithium hydride, thorium hydride, uranium hydride, thorium zirconium hydride, thorium titanium hydride, and a combination thereof into the porous network scaffold.

14. The method of claim 10, wherein removing the porous network scaffold to form a porous metal hydride article comprises forming the porous metal hydride article comprising a porosity of from about 0.01% by volume to about 20% by volume.

15. The method of claim 10, further comprising forming a protective interlayer over the porous network scaffold.

16. A method of regenerating a neutron moderator, comprising:
providing an at least partially depleted metal hydride article, the at least partially depleted metal hydride article comprising channels; and
introducing a hydrogen-containing gas into the at least partially depleted metal hydride article.

17. The method of claim 16, wherein introducing a hydrogen-containing gas into the at least partially depleted metal hydride article comprises increasing a hydrogen content of the at least partially depleted metal hydride article.

18. The method of claim 17, wherein introducing a hydrogen-containing gas into the at least partially depleted metal hydride article comprises substantially hydriding the at least partially depleted metal hydride article.

19. The method of claim 17, wherein introducing a hydrogen-containing gas into the at least partially depleted metal hydride article comprises flowing hydrogen gas through the channels of the at least partially depleted metal hydride article.

20. The method of claim 17, wherein introducing a hydrogen-containing gas into the at least partially depleted metal hydride article comprises regenerating about 20% or more of the at least partially depleted metal hydride article.
